(19) United States
(12) Patent Application Publication
(10) Pub. No.: US 2004/0255468 A1
(43) Pub. Date: Dec. 23, 2004

(54) Shears

(76) Inventor: Chih-Min Chang, Chang Hua Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 10/463,773

(22) Filed: Jun. 18, 2003

(51) Int. Cl. B26B 17/00

(52) U.S. Cl. 30/192

(57) ABSTRACT

A pair of shears includes a pair of cutting members, a connection assembly, and a pair of handles. Each of the cutting members includes a blade at a cutting end thereof. Each of the blades has two sloped cutting edges, a cutting fore end connecting the two sloped cutting edges and touchable by the other cutting fore end, and two cutting corners formed on the junctions of the two cutting edges and the cutting fore end. The connection assembly is mounted to the two cutting members for connecting and positioning the two cutting members. At least one cutting member includes a plurality of ditches arranged parallel to one another on at least one cutting edge thereof. Each of the ditches extends to the cutting fore end.

### BACKGROUND OF THE INVENTION

1. Field of the Invention

The present invention relates generally to shears, and more particularly, to improved cutting members of the shears, which prevent an object from slipping away while cutting the object and enhance cutting efficiency and utility while cutting an object which is sectionally round-shaped.

2. Description of the Related Art

The conventional shears 10, as shown in FIG. 1, are substantially composed of a pair of cutting members 11 and 12, a pair of pivoting members 13 and 14, and a pair of handles 15 and 16. The shears 10 are operated to cut hard objects by operating the handles 15 and 16 to drive the pivoting members 13 and 14 to pivot, the pivoting members 13 and 14 driving the cutting members 11 and 12 to change the interrelated positions of the cutting members 11 and 12 and their blades 21 and 22 and to further cut hard objects.

However, the shears are primarily used to cut sectionally round-shaped objects, such as electric cables, bolts, metal wires, metal bars, etc., such that the blades 21 and 22 of the cutting members 11 and 12 of the conventional shears 10 are not sharp to avoid ruptures of the blades 21 and 22 while cutting the sectionally-round objects. In other words, the blades 21 and 22 are not shaped like those of garden shears, which are sharper to cut out objects.

As shown in FIGS. 1 and 2, the blades 21 and 22 are alternatively provided with two sloped cutting edges 23 and 24, a cutting fore end 25 having a predetermined breadth, and two cutting corners 27 and 28 formed at bilateral sides of the cutting fore end 25.

The two cutting corners 27 and 28 are straight lines and the cutting edges 23 and 24 are smoothly flat, such that while the cutting the sectionally-round objects, the objects are apt to slip away from the blades 21 and 22 and the user cannot successfully cut the objects, thereby causing trouble and inconvenience for the user, as shown in FIG. 3.

### SUMMARY OF THE INVENTION

The primary objective of the present invention is to provide improved cutting members of shears, which facilitating cutting sectionally-round objects.

The secondary objective of the present invention is to provide improved cutting members of shears, which enhance cutting efficiency and utility and further facilitates the cutting.

The foregoing objectives of the present invention are attained by the improved cutting members of the shears. The shears are composed of a pair of the cutting members, a connection assembly, and a pair of handles. Each of the cutting members includes a blade at a cutting end thereof. Each of the blades has two sloped cutting edges, a cutting fore end connecting the two sloped cutting edges and touchable by the other cutting fore end, and two cutting corners formed on the junctions of the two cutting edges and the cutting fore end. The connection assembly is mounted to the two cutting members for connecting and positioning the two cutting members. At least one cutting member includes a plurality of ditches arranged parallel to one another on at least one cutting edge. Each of the ditches extends to the cutting fore end to lengthen the cutting corner, such that while cutting the sectionally-round objects, the objects can be held tight to be easily cut out without slipping away from the cutting edges.

### BRIEF DESCRIPTION OF THE DRAWINGS

FIG. 1 is an elevational view of a prior art;

FIG. 2 is a side view of a cutting member of the prior art;

FIG. 3 is a schematic view of the prior art at work;

FIG. 4 is an exploded view of a first preferred embodiment of the present invention;

FIG. 5 is a side view of a cutting member of the first preferred embodiment of the present invention;

FIG. 6 is an elevational view of the first preferred embodiment of the present invention;

FIG. 7 is a schematic view of two cutting members of the first preferred embodiment of the present invention at work;

FIG. 8 is an elevational view of a second preferred embodiment of the present invention; and

FIG. 9 is a side view of a cutting member of a third preferred embodiment of the present invention.

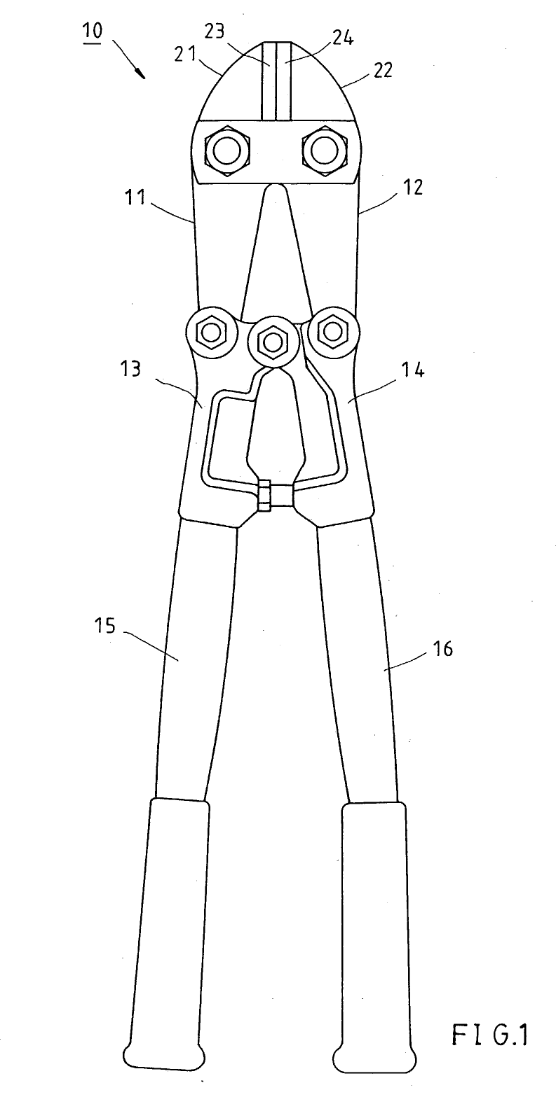

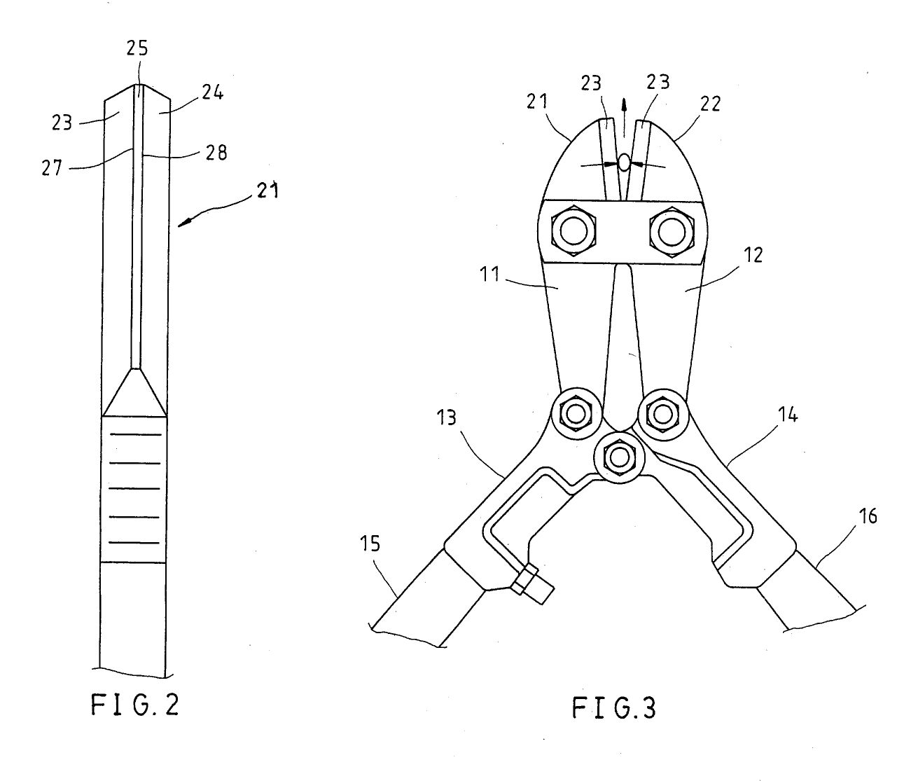

### DETAILED DESCRIPTION OF THE INVENTION

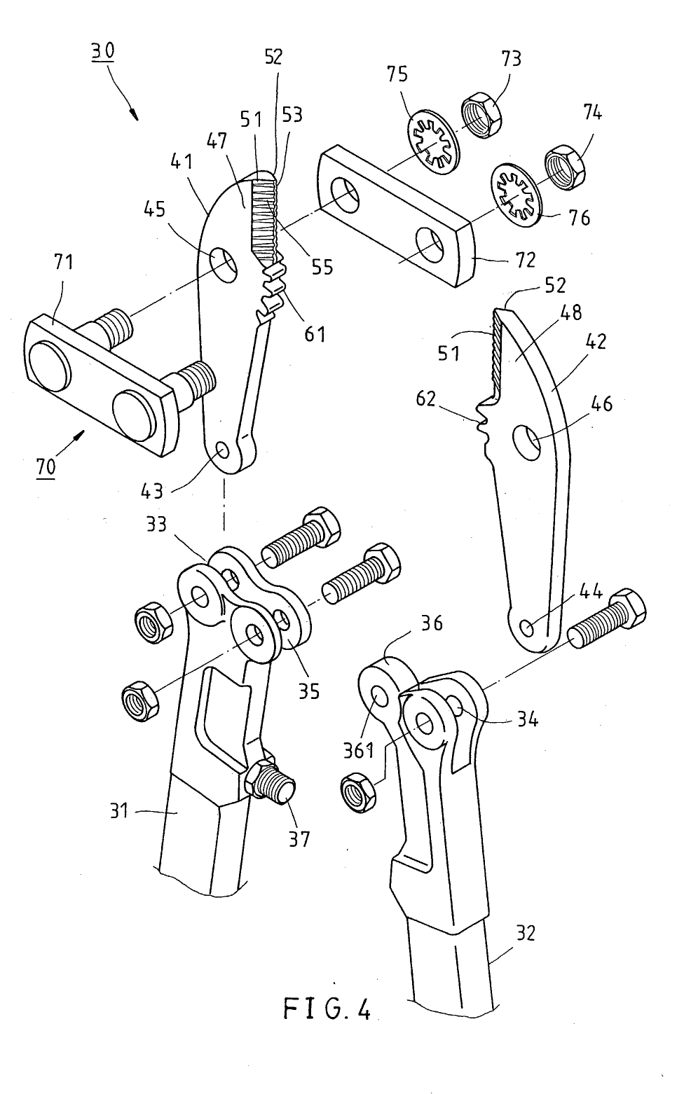

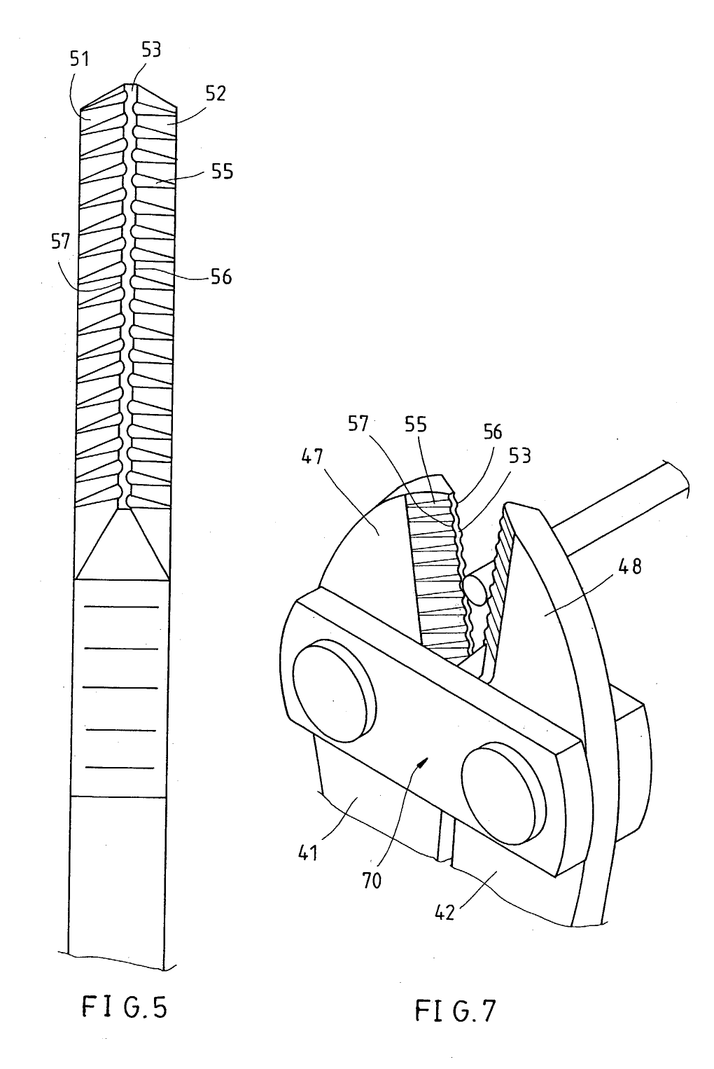

Referring to FIGS. 4-5, shears 30 constructed according to a first embodiment of the present invention comprise a pair of handles 31 and 32, a pair of cutting members 41 and 42, and a connection assembly 70.

The handles 31 and 32 are structurally corresponding to each other. The handle 31 includes two pivot holes 33 and 35 at a top end thereof and a stopping member 37 extending towards the handle 32 for preventing the two handles 31 and 32 from colliding with each other. The handle 32 includes a pivot hole 34, a pivoting portion 36, and a pivot hole 361 positioned at the center of the pivoting portion 36.

The two cutting members 41 and 42 each include a pivot hole 43(44) at distal ends thereof for pivotably connected with the two handles 31 and 32, a through hole 45 (46) running through middle positions thereof, and a tooth portion 61(62) positioned at opposite edges thereof for keeping the two cutting members 41 and 42 in preferable cutting positions. The two cutting members 41 and 42 each further include a blade 47(48) at cutting ends thereof. Each of the blade 47(48) is provided with two sloped cutting edges 51 and 52, a cutting fore end 53 connecting the two cutting edges 51 and 52, and two cutting corners 56 and 57 respectively formed on the conjunctions of the two cutting edges 51 and 52 and the cutting fore end 53. The cutting edges 51 and 52 are recessed with a plurality of ditches 55 arranged parallel to one another and being sectionally arched. The ditches 55 extend to the cutting fore end 53 to lengthen the cutting corners 56 and 57, such that while cutting the sectionally-round objects, the objects can be held tight to be easily cut out without slipping away from the cutting edges 51 and 52, as shown in FIG. 5.

The connection assembly 70 includes two pivoting pieces 71 and 72, a pair of screw nuts 73 and 74, and a pair of washers 75 and 76, and are connected with the two cutting members 41 and 42 by means of the through holes 45 and 46.

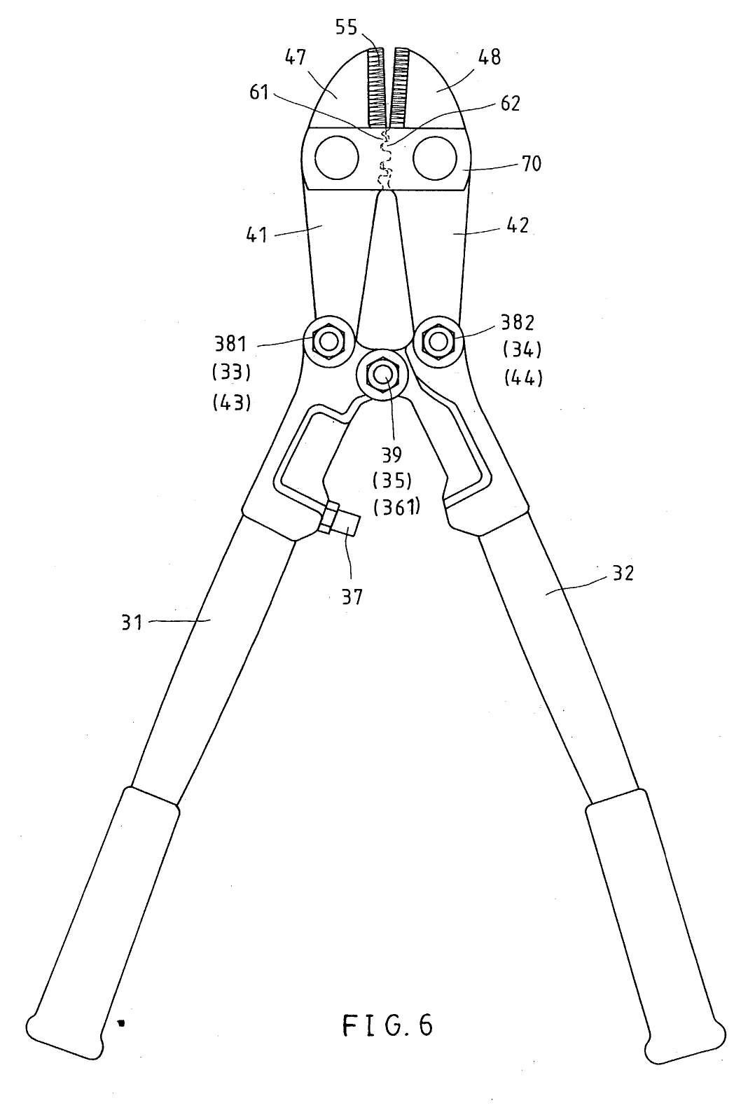

In combination, align the pivot holes 33 and 34 respectively with the pivot holes 43 and 44 and insert two bolts through the four pivot holes 33, 34, 43, and 44, thereby defining two pivoting junctions 381 and 382 by which the two cutting members 31 and 32 and the two handles 31 and 32 can pivot relatively to one another. Connect the connection assembly 70 and the cutting members 41 and 42 by the through holes 45 and 46 and the tooth portions 61 and 62 to enable the two cutting members 41 and 42 to pivotably cut. Align the pivot hole 35 with the pivot hole 361 and insert a bolt through the two pivot holes 35 and 361 to pivotally connect the pivoting portion 36 and the pivot hole 35, thereby defining a central pivot 39 by which the whole shears 30, as shown in FIG. 6, can pivotably cut the objects.

Referring to FIG. 7, while the shears 30 are operated to cut the objects, the ditches 55 can enhance the sharpness of the blades 47 and 48 of the cutting members 41 and 42 to keep the blades 47 and 48 durable against wear and breaches, and besides, while cutting the sectionally-round objects, the ditches 55 can prevent the objects from slipping away, thereby operating the shears 30 preferably smoothly.

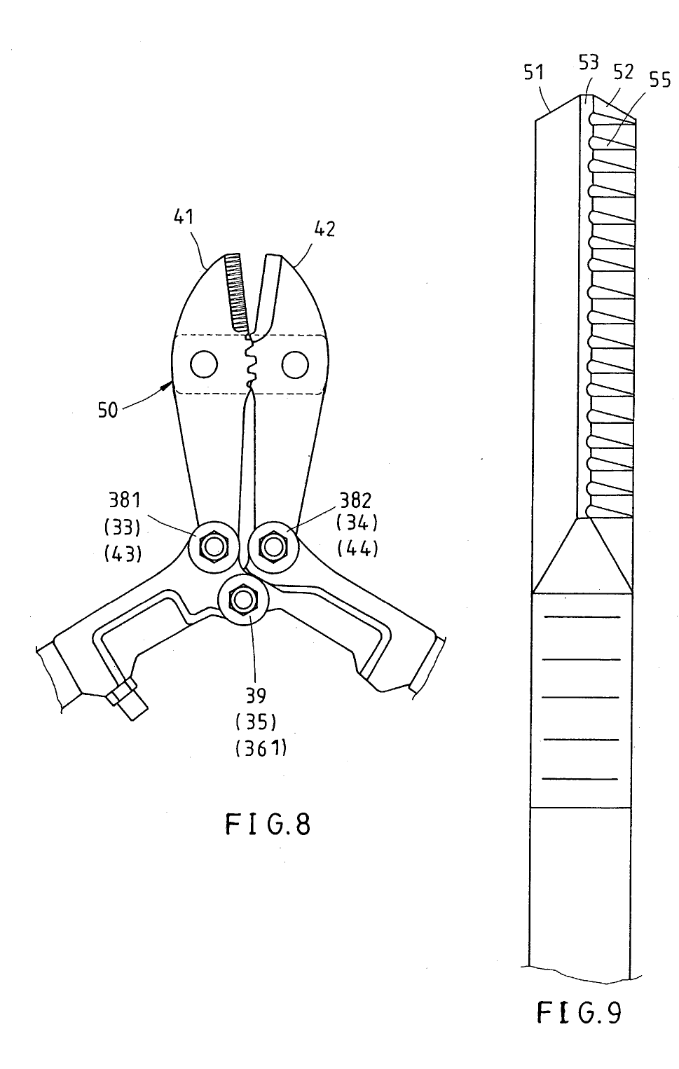

Referring to FIG. 8, the shears 30 constructed according to a second preferred embodiment of the present invention are different from the first preferred embodiment in that only one of the blades 47 and 48 of the cutting members 41 and 42 is recessed with a plurality of the ditches 55 on the cutting edges, and the other as the blades 21 and 22 of the prior art is smooth without the ditches.

Referring to FIG. 9, the shears 30 constructed according to a third preferred embodiment of the present invention are different from the aforementioned embodiments in that each of the blades 47 and 48 of the cutting members 41 and 42 is recessed with a plurality of the ditches 55 on one of the cutting edges. Alternatively, the ditches 55 can be sectionally V-shaped or others.

In conclusion, the shears of the present invention can effectively eliminate the drawback of the prior art, from which the sectionally-round objects easily slip away while cutting the objects, and enhance the cutting efficiency and utility.

What is claimed is:

1. A pair of shears comprising:
a pair of cutting members each having a blade at a cutting end thereof, each of said blades having two sloped cutting edges, a cutting fore end connecting said two sloped cutting edges, and two cutting corners at the junctions of said cutting fore end and said two cutting edges, said two cutting fore ends being touchable with each other;
a connection assembly mounted on said two cutting members for connecting and positioning said two cutting members;
a pair of handles having two pivoting junctions respectively at two top ends thereof for pivotally connecting said two cutting members; and
a plurality of ditches recessed on at least one of said cutting edges of at least one of said cutting members and arranged parallel to one another, each of said ditches extending to said cutting fore end.

2. The shears as defined in claim 1, wherein each of said ditches is sectionally arched in shape.

3. The shears as defined in claim 1, wherein each of said ditches is sectionally V-shaped.

4. The shears as defined in claim 1, wherein said connection assembly comprises two pivoting pieces, a pair of screw nuts, and a pair of washers.

5. The shears as defined in claim 1, wherein each of said two cutting members is recessed with said ditches at said two cutting edges.
